(19) United States
(12) Patent Application Publication
(10) Pub. No.: US 2007/0224111 A1
(43) Pub. Date: Sep. 27, 2007

(54) METHOD FOR PRODUCING HYDROGEN

(76) Inventors: Kenji ESSAKI, Kawasaki-shi (JP); Takehiko Muramatsu, Yokohama-shi (JP); Masahiro Kato, Naka-gun (JP); Yoshiyuki Isozaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/556,417

(22) Filed: Nov. 3, 2006

(30) Foreign Application Priority Data
Mar. 24, 2006 (JP) 2006-084082

(51) Int. Cl. C01B 3/26

(52) U.S. Cl. 423/652

(57) ABSTRACT

The invention provides a method for producing hydrogen which includes supplying a raw material gas and steam to a reactor filled with a reforming catalyst and a carbon dioxide gas absorbent containing a lithium composite oxide at a ratio of absorbent/catalyst by volume not lower than 9, and heating the inside of the reaction to a temperature range from 450° C. to 570° C., thereby carrying out reforming reaction.

### CROSS-REFERENCE TO RELATED APPLICATIONS

This application is based upon and claims the benefit of priority from prior Japanese Patent Application No. 2006-084082, filed Mar. 24, 2006, the entire contents of which are incorporated herein by reference.

### BACKGROUND OF THE INVENTION

1. Field of the Invention

The invention relates to a method for producing hydrogen using reforming reaction.

2. Description of the Related Art

Hydrogen (H₂) supplied as fuel to a fuel cell scarcely exists in nature. For this reason, hydrogen is mainly produced by a reforming method involving reaction of methane or fossil fuel such as kerosene as a raw material with high temperature steam (H₂O). For example, the reforming reaction of methane (CH₄), which is a main component of a natural gas or town gas is defined as the following reaction formula (1).

CH₄+2H₂O [symbol] 4H₂+CO₂ (1)

Also, recently, production of hydrogen using ethanol (C₂H₅OH), which is produced from plants and is drawing attention as a reproducible energy, as a raw material has been investigated. The reforming reaction of ethanol is defined as the following reaction formula (2).

C₂H₅OH+3H₂O [symbol] 6H₂+2CO₂ (2)

Since the reactions defined as the above-mentioned formulas (1) and (2) are accompanied with carbon monoxide (CO) and methane (CH₄) generation during the reaction, a large quantity of CH₄, CO and CO₂ as byproduct gases is generated together with hydrogen as a main product gas. Therefore, a gas refining step is required in the rear stage of a reforming reactor in which the reforming reaction is first carried out.

Depending on the type of an electrolyte, a fuel cell is classified mainly into phosphate type, molten carbonate type, solid oxide type, and solid polymer type. Among these types, a solid polymer type fuel cell is usable at a temperature close to room temperature and suitable for power generation in a relatively small scale of about 1 to 50 kW. Accordingly, use of the fuel cell as a dispersion type power source for domestic and industrial uses has been investigated. In a solid polymer type fuel cell, a noble metal such as platinum is mainly used for a fuel electrode to which fuel is supplied and an air electrode to which an oxidizing agent such as air is supplied. As a result, if carbon monoxide is contained in the fuel to be supplied to the fuel electrode of the fuel cell, carbon monoxide is irreversibly absorbed in platinum of the fuel electrode and poisons the electrode. For this reason, the power generation capability is decreased. Because of that, fuel with a carbon monoxide concentration of 10 ppm (0.001%) or lower is used for the fuel cell.

Although being different in accordance with the reaction conditions and raw materials, a product gas has a carbon monoxide concentration as high as several percent to several tens of percent immediately after the reforming reaction in a reactor. Therefore, in the case of using fuel containing hydrogen in a concentration of about 70% at atmospheric pressure just as in the case of the fuel cell for a dispersion type power source, generally a carbon monoxide conversion apparatus and a carbon monoxide removal apparatus utilizing preferential oxidation are successively connected in the rear stages of the reactor (refer to Frontline of Hydrogen Energy, Kogyo Chosakai, Publishing Co., Ltd., p. 36 [2003]). The reactions in the conversion apparatus and removal apparatus are defined by the following formulas (3) and (4).

CO+H₂O [symbol] H₂+CO₂ (3)

CO+(1/2)O₂ [symbol] CO₂ (4)

The carbon monoxide concentration of the product gas of the carbon monoxide conversion apparatus is lowered to about 0.5% immediate after conversion while the carbon monoxide concentration of the product gas of the carbon monoxide removal apparatus is lowered to about 0.001% immediate after CO removal, and thus carbon monoxide is almost completely removed.

However, the preferential oxidation by the carbon monoxide removal apparatus uses air as a supply source of oxygen (O₂) Therefore, an air introduction mechanism, air pump installation, air flow rate control, and the like are required. Further, since nitrogen (N₂) four times as much as oxygen is contained in air, introduction of air lowers the hydrogen concentration in the product gas.

For this reason, methanation for removing carbon monoxide by reaction with hydrogen produced by the reforming reaction has been investigated. The methanation is defined by the reaction formula (5).

CO+3H₂ [symbol] CH₄+H₂O (5)

However, in the methanation, not only hydrogen in the product gas is consumed by the reaction with carbon monoxide but also hydrogen is consumed by reaction with carbon dioxide, which is a byproduct gas in the reforming reaction defined by the following reaction formula (6). Although different in the product gas in accordance with the reforming reaction conditions and raw materials, the carbon dioxide concentration is as high as some tens of percent in the product gas after the carbon monoxide conversion apparatus.

CO₂+4H₂ [symbol] CH₄+3H₂O (6)

As described above, methanation is difficult to efficiently remove carbon monoxide although consuming a large quantity of hydrogen. As a result, so far, methanation has scarcely been employed for removing carbon monoxide and the above-mentioned preferential oxidation has been employed.

On the other hand, JP-A No. 2002-274809 (KOKAI) discloses use of lithium composite oxide as an inorganic carbon dioxide gas absorbent in addition to a reforming catalyst in the reactor for carrying out reforming. In this reactor, carbon dioxide produced as a byproduct in the reforming reaction from a high temperature reaction field exceeding 400° C. is removed by the carbon dioxide absorbent and the chemical equilibrium is shifted to the main product gas (hydrogen) production side, so that it becomes possible to efficiently obtain hydrogen. For example, in the case of methane, the equilibrium shift effect on the reaction with the high temperature steam is confirmed by experiments (refer to M. Kato et al, Journal of Ceramics Society of Japan, 113(3), 252 [2005]).

However, in the case of reforming of methane in the presence of the reforming catalyst and a lithium composite oxide, the above-mentioned patent application contains only a description of the condition of increasing the consumption ratio of methane.

Also, in 37th Autumn Conference of Chemical Engineering Society (2005), Suzuki et al, disclosed that both carbon monoxide and carbon dioxide produced aside could be lowered to less than 0.01% in the case of reforming of ethanol in the presence of a reforming catalyst and a lithium composite oxide. However, in this document, it is difficult to use the gas as fuel for a fuel cell as it is since the hydrogen concentration of the product gas is less than 50%.

### BRIEF SUMMARY OF THE INVENTION

According to the present invention, there is provided a method for producing hydrogen, which comprising:

supplying a raw material gas and steam to a reactor filled with a reforming catalyst and a carbon dioxide gas absorbent containing a lithium composite oxide at a ratio of absorbent/catalyst by volume not less than 9; and

heating the inside of the reaction to a temperature range from 450° C. to 570° C., thereby carrying out reforming reaction.

### BRIEF DESCRIPTION OF THE SEVERAL VIEWS OF THE DRAWING

FIG. 1 is a partial cross-sectional view showing a hydrogen producing apparatus to be used for production of hydrogen according to an embodiment;

FIG. 2 is a characteristic graph showing the relation between the volume ratio of absorbent/catalyst and the composition of the product gas; and

FIG. 3 is a characteristic graph showing the relation between the reforming temperature and the composition of the product gas.

### DETAILED DESCRIPTION OF THE INVENTION

Hereinafter, a hydrogen production method according to an embodiment of the invention will be described in detail with reference to drawings.

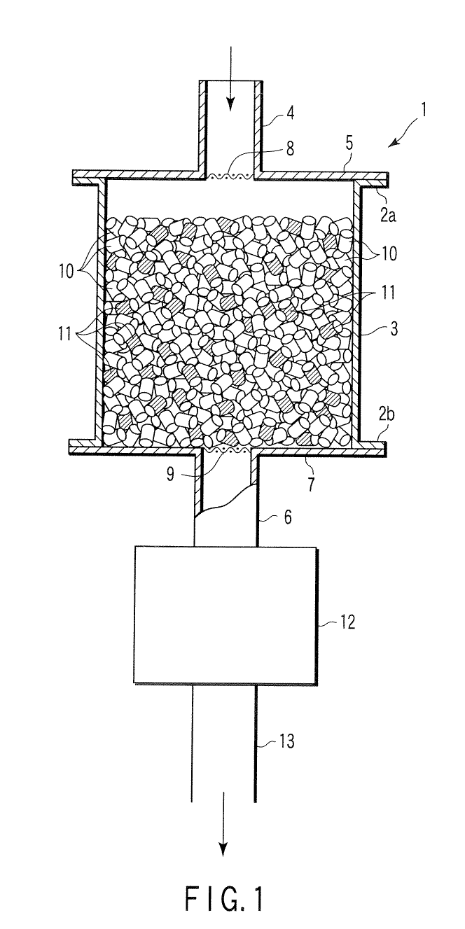

FIG. 1 is a partial cross-sectional view showing a hydrogen producing apparatus to be used for production of hydrogen according to an embodiment. A reforming reactor 1 includes a cylindrical main body 3 having flanges 2a, 2b at its both ends. An upper disk-like lid body 5 is contact with the flange 2a as one end (upper end) of the main body 3 and has a gas introducing pipe 4. A lower disk-like lid body 7 is in contact with the flange 2b as the other end (lower end) of the main body 3 and has a first product gas discharge pipe 6. The flanges 2a, 2b of the main body 3 have a plurality of opened bolt through-holes (not shown) respectively, and each of the disk-like lid bodies 5, 7 has also opened bolt through-holes (not shown) corresponding to these through-holes. The disk-like lid bodies 5, 7 are fixed to the main body 3 by respectively inserting bolts into the matched bolt through-holes of the flange 2a of the upper end of the main body 3 and upper disk-like lid body 5 and the matched bolt through-holes of the flange 2b of the lower end of the main body 3 and lower disk-like lid body 7 and tightening the bolts using nuts.

Meshes 8, 9 are respectively attached to an opening part of the gas introducing pipe 4 of the upper disk-like lid body 5 and an opening part of the first product gas discharge pipe 6 of the lower disk-like lid body 7. The main body 3 of the reforming reactor 1 is filled with a reforming catalyst 10 and a carbon dioxide absorbent 11 containing a lithium composite oxide in a mixed state.

The first product gas discharge pipe 6 is connected to a methanation reactor 12 which is filled with a methanation catalyst (not shown). A second product gas discharge pipe 13 is connected to the part of the methanation reactor 12 located on the opposite side to the first product gas discharge pipe 6.

Note that, a heating member (not shown) for flowing combustion gas heated to a predetermined temperature is provided on the outer peripheral surfaces of a portion of the gas introducing pipe 4 including the main body 3, the first and second product gas discharge pipes 6 and 13 and of a portion of the methanation reactor 12.

Next, a method for producing hydrogen according to an embodiment will be described using the hydrogen producing apparatus shown in FIG. 1.

First, the cylindrical main body 3 of the reforming reactor 1 is filled with the reforming catalyst 10 and the carbon dioxide absorbent 11 containing a lithium composite oxide (e.g., lithium silicate) at a ratio by volume of (absorbent 11)/(catalyst 10) not lower than 9. Successively, a raw material gas (e.g., methane) and steam are lead to the cylindrical main body 3 through the gas introducing pipe 4 and brought into contact with the reforming catalyst 10 and carbon dioxide absorbent 11 packed in the main body 3. In this case, a combustion gas is passed through a heating member (not illustrated) to heat the inside of the cylindrical main body 3 of the reforming reactor 1 to a temperature of 45° C. to 570° C. Reforming reaction of methane defined by the above-mentioned formula (1) is carried out in the presence of the reforming catalyst 10 by introducing the raw material gas and steam into the cylindrical main body 3 and heating the cylindrical main body 3 as described above. Hydrogen is produced by the reaction with steam and carbon dioxide and carbon monoxide, which are generated during the reaction, are generated as byproducts. Simultaneously, carbon dioxide is reacted and absorbed and removed according to the following formula (7) with the carbon dioxide absorbent (e.g., lithium silicate) 11 coexisting with the reforming catalyst 10. That is, the rightward reaction of carbon dioxide with lithium silicate in the following formula (7) is caused to absorb carbon dioxide. As a result, due to the effect of the equilibrium shift, the reforming reaction defined by the above-mentioned formula (1) is promoted.

Li₄SiO₄+CO₂ [symbol] Li₂CO₃+Li₂SiO₃ (7)

The produced gas is introduced into the methanation reactor 12 filled with the methanation catalyst through the first product gas discharge pipe 6 and there, mainly carbon monoxide is reacted with hydrogen according to the above-mentioned formula (5) and removed in form of methane. The product gas in the methanation reactor 12 is recovered through the second product gas discharge pipe 13.

The raw material gas may be hydrocarbons, oil, and alcohol. Particularly, methane, ethanol, kerosene, gases and liquid mainly containing them may be used preferably. In the case where the raw material is a liquid, the liquid is heated prior to or in the inside of the reforming reactor and evaporated and supplied in form of a gas.

The reforming catalyst may be a catalyst having a structure composed of a carrier and catalytic metal fine particles deposited on the carrier. Examples to be used as the carrier are alumina, magnesia, ceria, lanthanum oxide, zirconia, silica, and titania. The catalytic metal may be one metal selected from a group consisting of nickel, ruthenium, rhodium, palladium, platinum, and cobalt. Particularly, nickel and rhodium are preferable.

Examples of the carbon dioxide absorbent may include lithium composite oxide alone and mixtures of lithium composite oxide with alkali metal carbonate such as potassium carbonate and sodium carbonate and alkali metal oxides. Examples of the lithium composite oxide are lithium silicate as described and besides lithium zirconia and lithium ferrite. Particularly, lithium silicate is preferable as the lithium composite oxide. Lithium silicate defined by the following formula LiₓSi_{y}O_{z} (x+4y−2z=0) may be used. Examples to be usable as lithium silicate defined by the formula may include lithium orthosilicate (Li₄SiO₄), lithium metasilicate (Li₂SiO₃), Li₆Si₂O₇, Li₈SiO₆, and the like. Particularly, since it has a high temperature for absorption and desorption and is thus capable of separating carbon dioxide gas at a high temperature, lithium orthosilicate is preferable. These lithium silicates may have a composition more or less different from the stoichiometric ratio shown in the above-mentioned chemical formula.

The reforming catalyst and the carbon dioxide absorbent preferably have a granular or pellet shape and desirably have a diameter of 2 to 10 mm. If the size of them is smaller than 2 mm, the pressure loss due to the flow of the raw material gas and steam increases and the production efficiency of hydrogen may possibly be lowered. On the other hand, if the size of them exceeds 10 mm, the various gas diffused in the carbon dioxide absorbent becomes dominant to make completion of the reaction difficult.

The carbon dioxide absorbent is preferably a porous body having primary particles with a size of 2 to 50 μm and having a porosity of 30 to 70. The carbon dioxide absorbent of the porous body shows high reactivity with carbon dioxide.

In the reforming reaction, if the carbon dioxide absorbent is degraded in the absorption capacity because of absorption of carbon dioxide, the carbon dioxide absorbent can be regenerated. That is, the reaction of carbon dioxide absorbent (e.g., lithium silicate) with carbon dioxide is reversible as defined in the above-mentioned formula (7). Therefore, carbon dioxide can be released by heating the lithium silicate absorbing carbon dioxide to regenerate the lithium silicate.

As described, carbon dioxide absorbent (e.g., lithium silicate) contained the lithium composite oxide is capable of absorbing carbon dioxide and reproducible. Consequently, it is made possible to produce hydrogen almost continuously by previously making a plurality of reactors available, carrying out the reforming in at least one reaction container and simultaneously desorbing carbon dioxide from the carbon dioxide absorbent absorbing carbon dioxide in remaining reaction container.

Regeneration of the carbon dioxide absorbent is carried out in carbon dioxide atmosphere to recover the carbon dioxide desorbed from the carbon dioxide absorbent with high purity. This regeneration is preferable to be carried out at a condition of 900° C. or lower at atmospheric pressure. If the temperature at the time of regeneration exceeds 900° C., the deterioration of the carbon dioxide absorbent (e.g., lithium silicate) may possibly be severe. On the other hand, if regeneration of the carbon dioxide absorbent is carried out in an atmosphere of nitrogen or air containing almost no carbon dioxide, although recovery and use of carbon dioxide is limited, the regeneration can be carried out at a relatively low temperature, 550° C. to 70° C., at atmospheric pressure.

The reforming reaction and regeneration of the reforming reactor is preferable to be carried out for about 20 to 40 minutes. If the duration of the reforming reaction and regeneration is shorter than 20 minutes, the effect of the remaining gas at the time of switching becomes significant and it may decrease the efficiency in some cases. On the other hand, if the duration of the reforming reaction and regeneration is longer than 40 minutes, the amount of the absorbent has to be increased for maintaining the function during the reforming and it may decrease the efficiency in some cases.

At the time when the reforming catalyst and the carbon dioxide absorbent are packed in the reforming reactor, the mixing ratio by volume of them (absorbent/catalyst) is defined to be 9 or higher. In this case the volume ratio is calculated on the basis of the packed density separately measured for the absorbent and the catalyst and respective weights of them packed in the reforming reactor. Although the packed density differs in accordance with the types of catalyst and absorbent, in the case of using common materials, if the ratio is within the range, a product gas suitable for use for a fuel cell can be obtained. If the volume ratio of the absorbent/catalyst is lower than 9, it becomes difficult to sufficiently cause and maintain the effect of equilibrium shift at the time of reforming reaction for entire duration of the reforming reaction. If an excess amount of the absorbent exists in the reactor for the reforming reaction, excess heat energy is needed at the time of regeneration of the absorbent to be carried out thereafter. To avoid such a problem, it is preferable that the volume ratio of absorbent/catalyst is limited to at most 17. The volume ratio of absorbent/catalyst is more preferably in a range from 11 to 13.

The volume ratio of absorbent/catalyst is optimized in accordance with the reforming reaction and the switching time of regeneration of the absorbent and for example, if the switching time is long, the volume ratio is preferably a relatively large value within the above-mentioned range (9 or higher).

The reforming reaction temperature is defined in a range from 450 to 570° C. If the reforming reaction temperature is lower than 450° C., the carbon dioxide absorption speed is slow down in terms of reaction speed theory and the carbon dioxide concentration in the product gas cannot be decreased sufficiently and it becomes difficult to heighten the effect of equilibrium shift at the time of reforming reaction. On the other hand, if the reforming reaction temperature exceeds 570° C., it becomes difficult to lower the carbon dioxide concentration to 0.5% or lower and the effect of equilibrium shift becomes slight. It is attributed to that the carbon dioxide absorption by the carbon dioxide absorbent is an exothermic reaction and accordingly as the temperature is higher, the reaction is slower in terms of equilibrium. The reforming reaction temperature is more preferably in a range from 500 to 550° C.

The methanation reaction catalyst has a structure compose of an alumina carrier and ruthenium deposited thereon. The temperature of the methanation reactor is preferably in a range from 150 to 350° C. Heating of the methanation reactor may be carried out by using apparent heat of the product gas from the reforming reactor and heat transmission from the reforming reactor other than the use of the heating member using a combustion gas as described above.

According to the embodiment described above, the effect of equilibrium shift at the time of the reforming reaction of a raw material gas and steam is heightened by defining the packing ratio (absorbent/catalyst) by volume of the reforming catalyst and the carbon dioxide absorbent in the reactor to be 9 or higher and defining the reforming reaction temperature in a range from 450 to 570° C. In this case, even if one of the volume ratio of the absorbent/catalyst and the reforming temperature is defined, the effect equilibrium shift at the time of the reforming reaction of a raw material gas and steam cannot be heightened and the effect equilibrium shift at the time of reforming reaction can be heightened only in the case both are defined properly. As a result, efficient hydrogen production and decrease of the concentrations of carbon monoxide and carbon dioxide produced as byproducts can be lowered. That is, the embodiment provides a method for producing hydrogen which is capable of obtaining a product gas with 70% or higher hydrogen concentration and 0.5% or lower concentration of both of carbon monoxide and carbon dioxide and with no need of treatment in a carbon monoxide conversion apparatus.

In the case methanation reaction for removing carbon monoxide for lowering the carbon monoxide concentration in the product gas to 10 ppm or lower is carried out, since the product gas contains not only carbon monoxide but also carbon dioxide in a concentration of 0.5% or lower, the reaction of carbon dioxide and hydrogen defined by the above-mentioned formula (6) at the time of methanation reaction of carbon monoxide and hydrogen defined by the above-mentioned formula (5) can be suppressed. As a result, as compared with a conventional methanation reaction of the product gas containing hydrogen, carbon monoxide and carbon dioxide (particularly, the carbon dioxide concentration is high), hydrogen consumption can be saved corresponding to the low degree of carbon dioxide. Consequently, carbon monoxide can be decreased to 10 ppm or lower and the recovery ratio of hydrogen is remarkably improved.

Accordingly, since the product gas has 70% or higher hydrogen concentration and 10 ppm or lower concentration of carbon monoxide which poisons the catalyst of a fuel electrode in a solid polymer type fuel cell, the product gas can be use efficiently for fuel for the fuel cell.

Hereinafter, Examples within scope of the invention will be described.

### EXAMPLE 1

Hydrogen was produced using the above-mentioned hydrogen producing apparatus equipped with the reforming reactor 1 shown in FIG. 1. The reforming reactor 1 having a cylindrical main body 3 with an inner diameter of 0.02 m was employed. The cylindrical main body 3 was filled with 10 g of a catalyst and 46 g of a carbon dioxide absorbent. That is, the cylindrical main body 3 was filled with the catalyst and the carbon dioxide absorbent at a volume ratio of absorbent/catalyst of 10. As the catalyst was used an alumina carrier with an average particle diameter of 3 mm on which about 3% by weight of rhodium was deposited. The carbon dioxide absorbent was a powder-compacted body with a diameter of 5 mm, a length of 5 mm and porosity 60% obtained by pressure compacting lithium silicate powder.

Methane, a raw material gas, and steam at 1:4 by mole were introduced at a flow rate of 0.27 L/min (converted value in standard condition) into the cylindrical body of the reforming reactor through the introducing pipe 4. At that time, the temperature of the reforming reactor was set at 500° C.

### EXAMPLE 2

Hydrogen was produced by the same method as Example 1 using the same catalyst and carbon dioxide absorbent as those of Example 1, except that the amount of carbon dioxide absorbent was changed to 60 g and the cylindrical main body of the reforming reactor was filled with the catalyst and the carbon dioxide absorbent at a volume ratio of absorbent/catalyst of 13.

### EXAMPLE 3

Hydrogen was produced by the same method as Example 1 using the same catalyst and carbon dioxide absorbent as those of Example 1, except that the amount of carbon dioxide absorbent was changed to 74 g and the cylindrical main body of the reforming reactor was filled with the catalyst and the carbon dioxide absorbent at a volume ratio of absorbent/catalyst of 16.

### EXAMPLE 4

Hydrogen was produced by the same method as Example 1 using the same catalyst and carbon dioxide absorbent as those of Example 1, except that the amount of carbon dioxide absorbent was changed to 88 g and the cylindrical main body of the reforming reactor was filled with the catalyst and the carbon dioxide absorbent at a volume ratio of absorbent/catalyst of 19.

### COMPARATIVE EXAMPLE 1

Hydrogen was produced by the same method as Example 1 using the same catalyst and carbon dioxide absorbent as those of Example 1, except that the amount of carbon dioxide absorbent was changed to 32 g and the cylindrical main body of the reforming reactor was filled with the catalyst and the carbon dioxide absorbent at a volume ratio of absorbent/catalyst of 7.

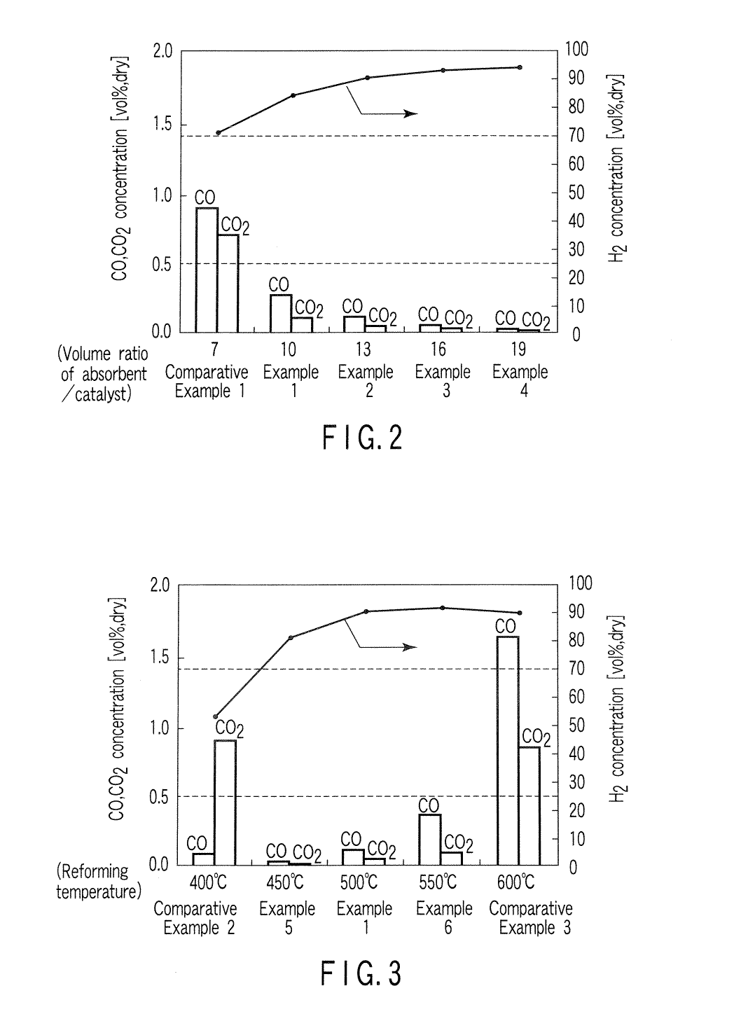

In hydrogen production in Examples 1, 2, 3, 4 and Comparative Example 1, after water was removed by cooling in the rear stage of the reforming reactor, the concentrations of hydrogen, carbon monoxide, and carbon dioxide were measured by Micro GC (trade name; CP 4900, manufactured by GL Sciences Inc.). Repeat of reforming and regeneration was simulated and the respective concentrations after 30 minutes from starting of the reforming were measured. The results are shown in FIG. 2.

Being made clear form FIG. 2, in the case of Examples 1, 2, 3 and 4 in which the volume ratio of catalyst/absorbent packed in the reforming reactor was 10, 13, 16 and 19, respectively, the hydrogen concentration in the product gas was as high as 80% or higher and carbon monoxide concentration was lower than 0.5%, and therefore, it could be understood that the treatment by a carbon monoxide conversion apparatus, one of refining steps, was not necessary. However, in the case of Example 4 in which the volume ratio of catalyst/absorbent is as high as 19, since the amount of the absorbent was increased, excess heat was required at the time of regeneration along with the increase of the absorbent amount.

On the other hand, in the case of Comparative Example 1 in which the volume ratio of catalyst/absorbent packed in the reforming reactor was 7, the hydrogen concentration in the product gas was approximately 70% and carbon monoxide concentration was about 0.8%, higher than 0.5%, and therefore, it could be understood that the treatment by a carbon monoxide conversion apparatus, one of refining steps, was required.

Next, in Examples 1, 2, and 3 and Comparative Example 1, a methanation reactor 12 was connected to the rear stage of the reforming reactor through a first product gas discharge pipe 6 as shown in FIG. 1 and the product gas from the reforming reactor 1 was subjected to methanation reaction. That is, a cylindrical reactor with an inner diameter of 0.02 m and closed in the upper and lower sides was used as the methanation reactor 12. The methanation reactor 12 was filled with 20 g of a catalyst having an alumina particle carrier with an average particle diameter of 3 mm and about 2% by weight of ruthenium deposited thereon.

In the above-mentioned state, each product gas obtained by reaction in the cylindrical main body 3 of the reforming reactor 3 in Examples 1, 2, and 3 and Comparative Example 1 was supplied to the methanation reactor 12 through the first product gas discharge pipe 6 and subjected to the methanation reaction. In this case, the first product gas discharge pipe 6 was heated with a heating member so as to keep the temperature at about 300° C. or higher to prevent water condensation. Also, the methanation reactor 12 was controlled to be at 250° C. After water was removed by cooling in the rear stage of the methanation reactor, the concentrations of hydrogen, carbon monoxide, and carbon dioxide were measured by Micro GC (trade name; CP 4900, manufactured by GL Sciences Inc.).

As a result, in the methanation reaction of the product gases of Examples 1, 2 and 3, product gases with hydrogen concentration of 80% or higher were obtained even after 30 minutes after the starting of reforming and carbon monoxide and carbon dioxide were scarcely detected and estimated to be 10 ppm or lower. It is, as shown in FIG. 2 described above, attributed to that the product gases obtained by the reforming reaction contained carbon monoxide and carbon dioxide in concentrations decreased to 0.5% or lower. The product gases after methanation reaction had hydrogen concentration as high as 80% or higher and the concentration of carbon monoxide which poisons a catalyst of a fuel electrode so low as to make detection impossible (estimated to be 10 ppm or lower) and therefore, they were suitable to be used as fuel for a solid polymer type fuel cell.

On the other hand, in the methanation reaction of the product gas of Comparative Example 1, the hydrogen concentration was decreased to 68%, lower than 70% and carbon monoxide was only decreased to 2000 ppm (0.2%). Therefore, the product gas after the methanation reaction was unsuitable to be used as fuel for a solid polymer type fuel cell.

### EXAMPLE 5

Hydrogen was produced by the same method as Example 1, except that the temperature of the reforming reactor was changed to be 450° C.

### EXAMPLE 6

Hydrogen was produced by the same method as Example 1, except that the temperature of the reforming reactor was changed to be 550° C.

### COMPARATIVE EXAMPLE 2

Hydrogen was produced by the same method as Example 1, except that the temperature of the reforming reactor was changed to be 400° C.

### COMPARATIVE EXAMPLE 3

Hydrogen was produced by the same method as Example 1, except that the temperature of the reforming reactor was changed to be 600° C.

In the hydrogen production in Examples 5 and 6 and Comparative Examples 2 and 3, after water was removed by cooling in the rear stage of the reforming reactor, the concentrations of hydrogen, carbon monoxide, and carbon dioxide were measured by Micro GC (trade name; CP 4900, manufactured by GL Sciences Inc.). Repeat of reforming and regeneration was simulated and the respective concentrations after 30 minutes from starting of the reforming were measured. The results are shown in FIG. 3. The results of Example 1 in which the temperature of the reforming reactor was set to be 500° C. are shown together in FIG. 3.

Being made clear from FIG. 3, in the case of Examples 5, 1, and 6 in which the temperature of the reforming reactor was set at 450° C., 500° C., and 550° C., the hydrogen concentration in the product gas was as high as 80% or higher and carbon monoxide concentration was lower than 0.5%, and therefore, it could be understood that the treatment by a carbon monoxide conversion apparatus, one of refining steps, was not necessary.

On the other hand, in the case of Comparative Example 2 in which the temperature of the reforming reactor was set at 400° C., the hydrogen concentration in the product gas was as low as 53% although carbon monoxide concentration was lower than 0.5%. That the carbon monoxide concentration in the product gas became low may be attributed to that because the reforming temperature was low and the exothermic reaction defined by the above-mentioned formula (1) tends to be promoted in terms of equilibrium and the equilibrium shift effect become high. It is also understood from that the carbon dioxide at 400° C. reforming temperature was also high. However, although the temperature of 400° C. is suitable for the reforming reaction, at the time carbon dioxide absorption, the temperature is low and the reaction speed is decreased and accordingly the carbon dioxide concentration becomes high.

Also in the case of Comparative Example 3 in which the temperature of the reforming reactor was set at 600° C., carbon monoxide concentration was also as high as 1.6% although the hydrogen concentration in the product gas was as high as 90%. For this reason, the treatment by a carbon monoxide conversion apparatus, one of refining steps, was required. It is attributed to that since the temperature at the time of carbon dioxide absorption by the absorbent defined by the above-mentioned formula (7) was high, it became difficult to absorb carbon dioxide to a low concentration and the equilibrium shift effect was lowered.

Next, in Examples 5 and 6, a methanation reactor 12 was connected to the rear stage of the reforming reactor through a first product gas discharge pipe 6 as shown in FIG. 1 and the product gas from the reforming reactor 1 was subjected to methanation reaction. That is, a cylindrical reactor with an inner diameter of 0.02 m and closed in the upper and lower sides was used as the methanation reactor 12. The methanation reactor 12 was filled with 20 g of a catalyst having an alumina particle carrier with an average particle diameter of 3 mm and about 2% by weight of ruthenium deposited thereon.

In the above-mentioned state, each product gas obtained by reaction in the cylindrical main body 3 of the reforming reactor 3 in Examples 5 and 6 was supplied to the methanation reactor 12 through the first product gas discharge pipe 6 and subjected to the methanation reaction. In this case, the first product gas discharge pipe 6 was heated with a heating member so as to keep the temperature at about 300° C. or higher to prevent water condensation. Also, the methanation reactor 12 was controlled to be at 250° C. After water was removed by cooling in the rear stage of the methanation reactor, the concentrations of hydrogen, carbon monoxide, and carbon dioxide were measured by Micro GC (trade name; CP 4900, manufactured by GL Sciences Inc.).

As a result, in the methanation reaction of the product gases of Examples 5 and 6, product gases with hydrogen concentration of 80% or higher were obtained even after 30 minutes after the starting of reforming and carbon monoxide and carbon dioxide were scarcely detected and estimated to be 10 ppm or lower. It is, as shown in FIG. 3 described above, attributed to that the product gases obtained by the reforming reaction contained carbon monoxide and carbon dioxide in concentrations decreased to 0.5% or lower. The product gases after methanation reaction had hydrogen concentration as high as 80% or higher and the concentration of carbon monoxide which poisons a catalyst of a fuel electrode so low as to make detection impossible (estimated to be 10 ppm or lower) and therefore, they were suitable to be used as fuel for a solid polymer type fuel cell.

On the other hand, with respect to the product gas of Comparative Example 2, the hydrogen concentration was lower than 70% in the reforming reactor and with respect to the product gas of Comparative Example 3, carbon monoxide was very high and required previous treatment by a carbon monoxide conversion apparatus and therefore, the above-mentioned methanation reaction by the methanation reactor was not carried out.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A method for producing hydrogen comprising:
supplying a raw material gas and steam to a reactor filled with a reforming catalyst and a carbon dioxide gas absorbent containing a lithium composite oxide at a ratio of absorbent/catalyst by volume not lower than 9; and
heating the inside of the reactor to a temperature range from 450° C. to 570° C., thereby carrying out reforming reaction.

2. The method according to claim 1, wherein the raw material gas is a hydrocarbon, oil, or alcohol.

3. The method according to claim 1, wherein the reforming catalyst has a structure where a catalyst metal particle of at least one selected from the group consisting of nickel, ruthenium, rhodium, palladium, platinum and cobalt is supported on a carrier selected from alumina, magnesia, ceria, lanthanum oxide, zirconia, silica and titania.

4. The method according to claim 1, wherein the reforming catalyst has a granular or pellet shape and has a diameter of 2 to 10 mm.

5. The method according to claim 1, wherein the lithium composite oxide is lithium silicate.

6. The method according to claim 1, wherein the carbon dioxide absorbent is a porous body having particles of 2 to 50 μm and a porosity of 30 to 70%.

7. The method according to claim 1, wherein the reactor is filled with the reforming catalyst and the carbon dioxide absorbent at a volume ratio of absorbent/catalyst not lower than 9 and lower than 17.

8. The method according to claim 1, wherein the reactor is filled with the reforming catalyst and the carbon dioxide absorbent at a volume ratio of absorbent/catalyst in a range from 11 to 13.

9. The method according to claim 1, wherein the heating is carried out at a temperature in a range from 500 to 550° C.

10. The method according to claim 1, wherein the product gas discharged out of the reactor is further supplied to a methanation reactor filled with a methanation reaction catalyst and carbon monoxide in the product gas is subjected to methanation reaction.

11. The method according to claim 10, wherein the methanation reaction catalyst has a structure comprising an alumina carrier and ruthenium deposited thereon.

12. The method according to claim 10, wherein the methanation reaction is carried out by heating the inside of the methanation reactor in a temperature range from 150 to 350° C.
